(19) United States
(12) Patent Application Publication
(10) Pub. No.: US 2022/0386580 A1
(43) Pub. Date: Dec. 8, 2022

(54) SELF-STANDING FOLD-UP FISHING ROD STAND

(71) Applicant: Prescott B. Hardy, Lehi, UT (US)

(72) Inventor: Prescott B. Hardy, Lehi, UT (US)

(21) Appl. No.: 17/678,916

(22) Filed: Feb. 23, 2022

Related U.S. Application Data
(60) Provisional application No. 63/197,268, filed on Jun. 4, 2021.

(51) Int. Cl. A01K 97/10

(52) U.S. Cl. CPC A01K 97/10

(57) ABSTRACT

A fishing rod stand includes a swivel plate, a first front support, a second front support, and a back support. The first front support is connected to a first distal end of the swivel plate, and forms a first cradle configured to support a fishing rod. The second front support is connected to the first distal end of the swivel plate. The back support is connected to a second distal end of the swivel plate.

### REFERENCE TO RELATED APPLICATIONS

The present application claims the benefit of priority under 35 U.S.C. § 119 from U.S. Provisional Patent Application Ser. No. 63/197,268 entitled “TRIPOD SELF-STANDING FOLD-UP FISHING ROD STAND,” filed on Jun. 4, 2021, the disclosure of which is hereby incorporated by reference in its entirety for all purposes.

### TECHNICAL FIELD

The present disclosure generally relates to a fishing rod stand, and more particularly to apparatuses and methods for a self-standing fold-up fishing rod stand.

### BACKGROUND

Fishing is a common pastime for many people. A common type of fishing includes bank fishing in which the fisherman casts a fishing line from where land meets the water, such from a lake-, stream-, or river-bank. Another common type of fishing is still-water fishing (or still fishing), in which the fisherman places bait at the end of a fishing line in water and waits for fish to take the bait. Another common type of fishing is ice fishing in which the fisherman places bait at the end of a fishing line into a hole cut above water and waits for fish to take the bait. These types of fishing, as well as others, may involve extended periods of time where the fishing rod is to remain in the same place.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a front perspective of a fishing rod stand in use in an unfolded configuration with exemplary elongated objects for reference, according to certain embodiments.

FIG. 2 illustrates a front perspective view of a fishing rod stand in an unfolded configuration, according to certain embodiments.

FIG. 3 illustrates a side view of a fishing rod stand in an unfolded configuration, according to certain embodiments.

FIG. 4 illustrates a side view of a fishing rod stand in a folded configuration, according to certain embodiments.

FIG. 5 illustrates a standalone view of a front support, according to certain embodiments.

FIG. 6 illustrates a standalone view of a back support, according to certain embodiments.

FIG. 7 illustrates a standalone view of a swivel plate, according to certain embodiments.

FIG. 8 illustrates a close-up side cross-sectional view of a fishing rod stand, according to certain embodiments.

FIG. 9 illustrates a front perspective view of a fishing rod stand in an unfolded configuration, according to certain embodiments.

### DETAILED DESCRIPTION

Aspects of the present disclosure are directed to a self-standing fold-up fishing rod stand that functions in a variety of weather and ground conditions. Conventional fishing rod stands are designed to be attached to the ground on which they sit. For example, some conventional fishing rod stands have spikes that are driven into the ground to provide stability, while other conventional fishing rod stands may have clamps that are meant to attach to a dock to provide stability. Hence, the use of conventional fishing rod stands is limited by the different ground types encountered in fishing environments. For example, a fishing rod stand that has spikes for stability cannot practically be used on a boat dock, while a fishing rod stand with a clamp for stability cannot practically be used on a shoreline.

Aspects of the present disclosure overcome the above-noted and other deficiencies by providing a self-standing fishing rod stand (referred to herein as “fishing rod stand”) that can be used in a variety of fishing environments. The fishing rod described herein is lightweight and easy to carry to a variety of fishing locations. The fishing rod can be used on almost any type of ground, such as a dock, on ice, or on a waterfront, including next to a river, next to a stream, or at a bank of a lake. In some embodiments, the fishing rod stand includes fishing rod cradles and three retractable legs connected to a swivel plate. In some embodiments, two fishing rod cradles enable simultaneous use of two fishing rods. In some embodiments, the fishing rod stand includes a handle.

The fishing rod stand includes a swivel plate, a front support (e.g., a front support with a cradle capable of supporting a fishing rod) connected to the swivel plate, a second front support connected to the swivel plate, and a back support connected to a distal end of the swivel plate.

An elongated object stand includes a swivel plate, a front support (e.g., a front support capable of supporting an elongated object) connected to the swivel plate, a second front support connected to the swivel plate, and a back support rotatably connected to the swivel plate and capable of resting on an external surface (e.g., the ground).

In some embodiments, the fishing rod stand includes four structural parts, namely two fishing rod cradles (which may also act as the front supports), a support (which may be in the back), and a swivel plate. Because the fishing rod stand is self-standing, it can be used on a variety of ground conditions a fisherman may encounter. The fishing rod stand can be unfolded and ready to use quickly (e.g., in less than one minute), and can be set up on almost any surface, terrain, or topography, including sand, rocks, hard or frozen soil, ice, concrete, a dock, and/or a boat deck.

Additionally, in some embodiments, the fishing rod stand can fold to a compact and manageable size. In some embodiments, the folded fishing rod stand (e.g., the fishing rod stand in a folded configuration) is about one to about four inches wide, about one-half inch to about three inches deep, and about twelve to about thirty-six inches long. For example, a folded fishing rod stand may be about three inches wide by about one-and-a-half inches deep by about twenty-four inches long (3″×1.5″×24″). In some embodiments, the length of a fishing rod can be between about 20 inches and about 30 inches. This compact size can make it easy to transport to the desired fishing spot, whether it be a short walk to a lake or a prolonged backpack trip. The compact size, especially when folded, further enables easy storage. The fishing rod stand can have front supports ranging from about sixteen inches to about thirty-six inches, a back support that measures between about ten inches and about twenty-eight inches, and a swivel plate that measures between about 1 and about 10 inches. Persons skilled in the art would realize that the dimensions disclosed here are for illustrative purposes and do not limit the scope of the disclosure. Other dimensions of the structural parts are possible.

In some embodiments, the fishing rod stand can be constructed of durable and water resistant marine plywood. As used herein, water resistant marine plywood refers to plywood made with waterproof glue which will not dissolve when wet, and which water resistant marine plywood is commonly used in the construction of boats. In some embodiments, the fishing rod stand can be constructed using fiberglass, plastic, other wood, and/or aluminum. As used herein, a rigid material will hold its general shape before and after a force (e.g. at least about 50 lbs of force) is applied to the material. A rigid material may flex or bend slightly (e.g., undergo elastic deformation) when a force is applied, but will not undergo plastic deformation, collapse, or fracture under moderate to strong applied forces. As used herein, a water-resistant material will resist damage from liquids such as water. A water-resistant material may substantially hinder, but not entirely prevent damage to a material from liquids such as water.

In some embodiments, the structural parts (e.g., front supports, back support, swivel plate, etc.) can be built from (e.g., cut from) about 4 feet wide by about 8 feet long (4′×8′) sheets of marine plywood. In addition to the water resistance of the marine plywood, a coat of water seal can be applied to the sheet providing the fishing rod stand with additional protection against foul weather. The cut edges of each structural part (e.g., front supports, back support, swivel plate, etc.) can be coated with a wood seal which provides further protection to the structural pieces by preventing absorption of liquids or other degradation through contact with liquids, such as water, at a fishing location. In some embodiments the structural parts cut from the about 4′×8′ sheet of marine plywood can be cut manually, with a table saw, a router, or another cutting tool or with a computer controlled program such as, for example, a CNC (computer numerical control) machine.

In some embodiments, the hardware used to assemble the fishing rod stand is rust resistant zinc-plated steel, stainless steel, aluminum, other corrosion resistant metal, plastic, nylon, or other corrosion resistant material. In some embodiments, additional weight may be added to a fishing rod stand) to further increase the stability of the stand. In some embodiments, the material used to construct fishing rod stand determines how much weight should be added to increase stability.

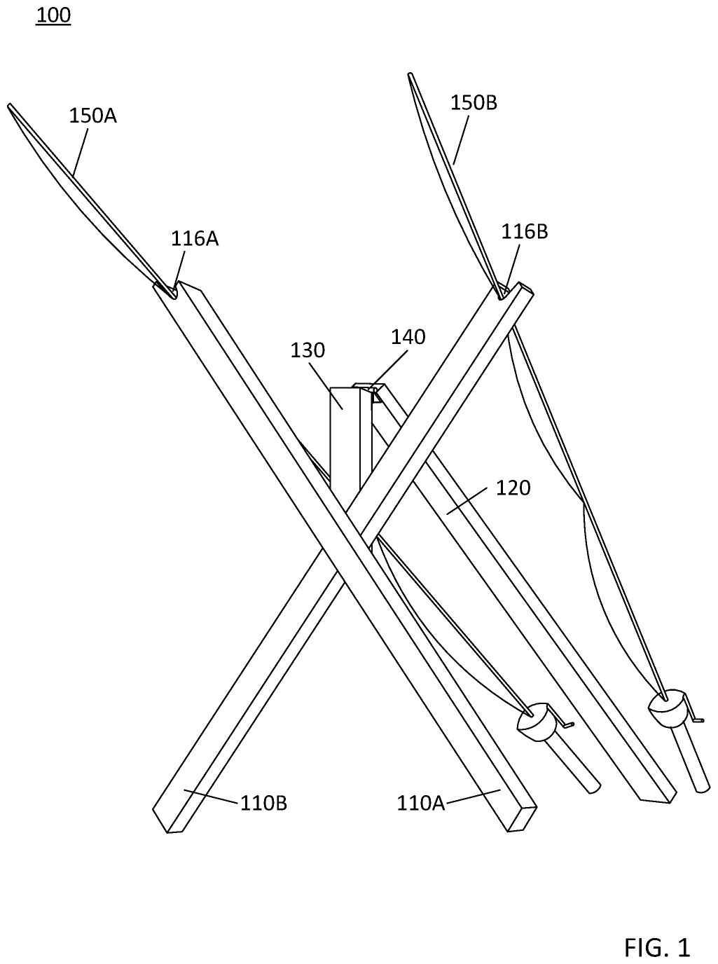

FIG. 1 illustrates a front-side perspective of one embodiment of a fishing rod stand 100 in use in an unfolded configuration, with exemplary elongated objects 150A-150B for reference. The fishing rod stand 100 includes two front supports 110A-110B and a back support 120 connected to a swivel plate 130. In some embodiments, front supports 110A and 110B are rotated into an “X” formation. Back support 120 is extended away from swivel plate 130 to create a stable tripod-like support. In some embodiments, when in use, back support 120 extends towards the user, and front supports 110A and 110B face the fishing location (e.g., the water).

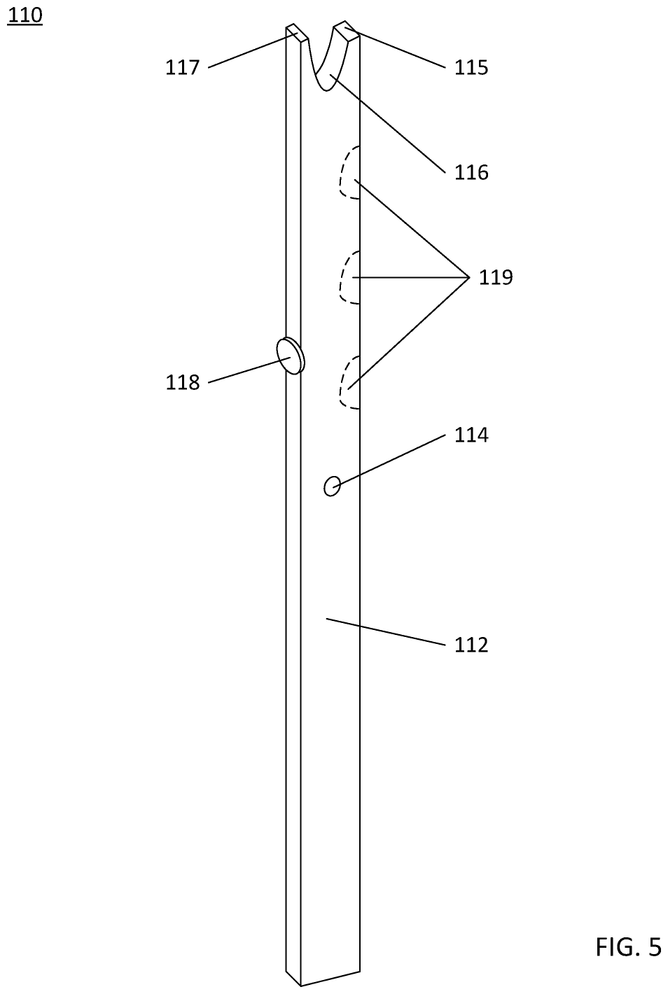

Elongated objects 150A and 150B may be placed in cradles 116A and 116B on front supports 110A and 110B as shown. Cradle 116 is configured to support elongated object 150, and is further described along with front support 110 with respect to FIG. 5. In some embodiments, elongated object 150 is a narrow extruded shape resembling a rod or pole. In some embodiments, elongated object 150 has a handle. In some embodiments, elongated object 150 resemble a narrow cylinder or prism with a length substantially greater than both the width and thickness of the elongated object. In some embodiments, elongated object 150 is a fishing rod. In some embodiments, elongated object 150 is a cooking spit, such as a marshmallow or hot dog roasting stick. In some embodiments, elongated object 150 is the barrel of a gun, such as a hunting rifle. In some embodiments, elongated objects 150A-150B may also be placed in the crook of the “X” (not pictured) formed by front supports 110A or 110B and swivel plate 130. For example, in one embodiment an elongated object 150 such as a fishing rod may be supported between the front support 110A and swivel plate 130 and another fishing rod may be supported between the front support 110B and swivel plate 130. In this way, fishing rod stand 100 may potentially accommodate four separate fishing rods. In some circumstances, such as ice fishing, it may be advantageous to put the first and/or second fishing rods in the crook of the “X” made by front supports 110A or 110B and swivel plate 130. In some embodiments, fishing rod stand 100 supports several elongated objects 150 which are not presently in use, such as, for example, by acting as a support or storage for unused fishing rods. In some embodiments, fishing rod stand 100 only supports elongated objects 150 which are presently in use, such as, for example, by supporting a fishing rod with a cast line. In some embodiments, front supports 110A and 110B may be adjusted to counteract negative impacts of the environment, such as, for example, high velocity winds.

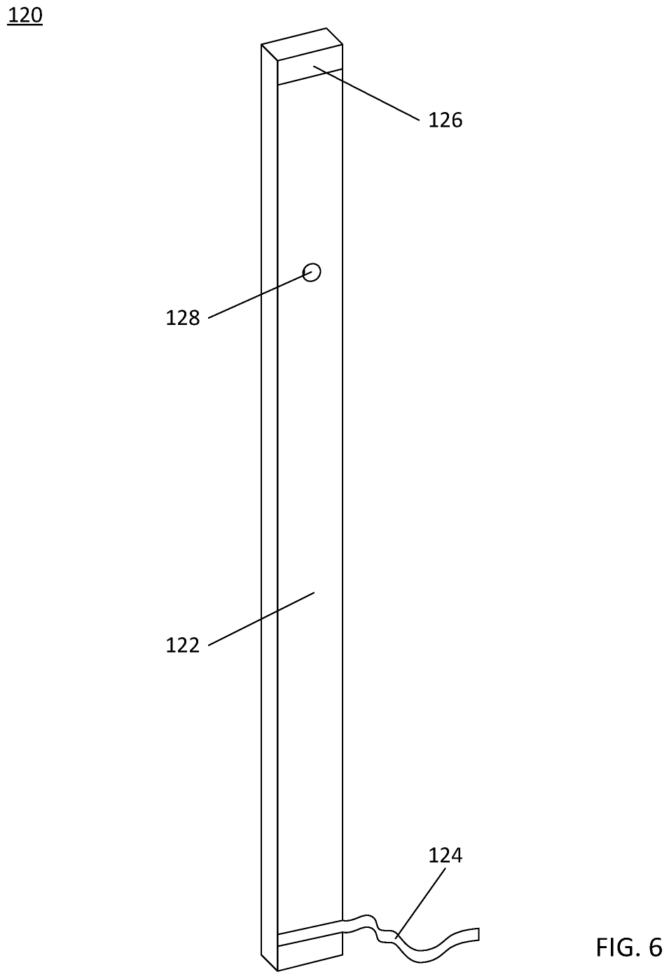

In some embodiments, back support 120 and swivel plate 130 are coupled using hinge 140 (e.g., first portion of hinge 140 is secured to back support 120 and second portion of hinge 140 is secured to swivel plate 130) as further described with respect to FIGS. 6-8. In some embodiments swivel plate 130 and back support 120 can be placed in a support structure such as a jig while securing hinge 140 to ensure hinge 140 is properly installed. In some embodiments, back support 120 and swivel plate 130 each extend past hinge 140 (not pictured) such that the interaction between extended parts of back support 120 and swivel plate 130 would prevent hinge 140 from opening too far. In some embodiments, hinge 140 is a tension or positioning hinge which retains its rotated position through internal friction or other means internal to the hinge.

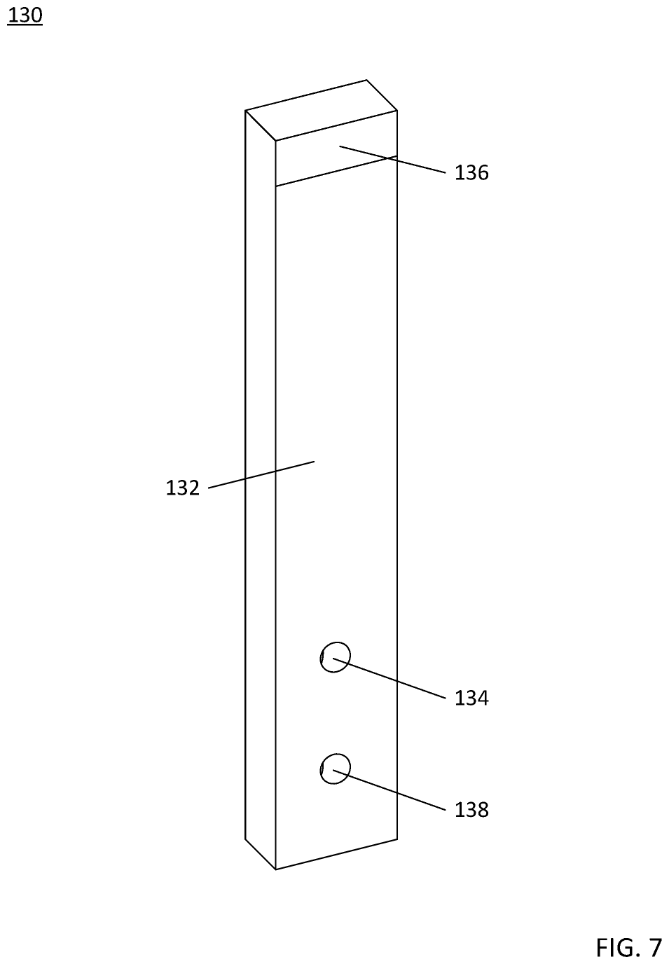

Fishing rod cradles 116A and 116B along with front supports 110A and 110B are further described with respect to FIG. 5. Back support 120 is further described with respect to FIG. 6. Swivel plate 130 is further described with respect to FIG. 7.

The fishing rod stand 100 can be set up by holding the bottom of the front support 110A, and simultaneously grasping the bottom of front support 110B and rotating each until the tops of each front support 110A and 110B are centered in a shape resembling an “X.” Back support 120 is now centered in the upper portion of the “X” created by front supports 110A and 110B. Back support 120 is extended (e.g., rotated via hinge 140) away from swivel plate 130. In this way, fishing rod stand 100 may be used on any type of ground with back support 120 typically facing away from the water, and towards a user.

After opening fishing rod stand 100, some embodiments may be used by resting a fishing rod in cradle 116 of front support 110 at an angle which will allow detection of even the smallest nibble from a fish. In some embodiments, the fishing rod may rest at about a 35 to about a 55 degree angle in cradle 116.

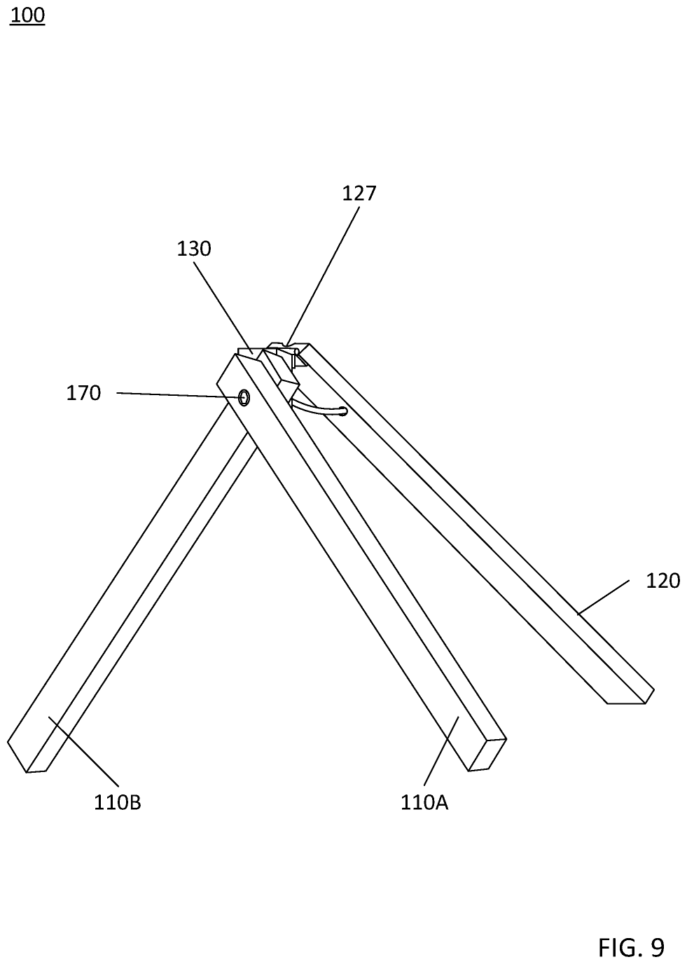

In some embodiments, fishing rod stand 100 is made to support only one elongated object 150 (not pictured). In one embodiment, a notch at the top of back support 120 for an elongated object 150 (not pictured). In some embodiments, supports 110A and 110B do not extend more than about one-half inch to about two inches past their pivot point, as further described with respect to FIG. 9. In some embodiments, fishing rod stand 100 includes additional feet (not pictured) which attach to the bottoms of front supports 110A and 110B as well as the bottom of back support 120. In some embodiments, the additional feet are made of rubber, or another material or surface with a coefficient of friction that is greater than that of plywood. In some embodiments, distance between the tops of front supports 110A and 110B is less than distance between the bottoms of front supports 110A and 110B when fishing rod stand 100 is in an unfolded configuration.

In some embodiments, more or less components (e.g., structural parts, hardware, fasteners, front support 110, etc.) may be used than those shown in one or more of the FIGs. The use or inclusion of specific components (e.g., front support 110) do not describe every embodiment and are intended only as a reference. Additionally, the angles shown or suggested are not the only usable angles for the fold-up fishing rod stand 100 and are similarly intended only as a reference.

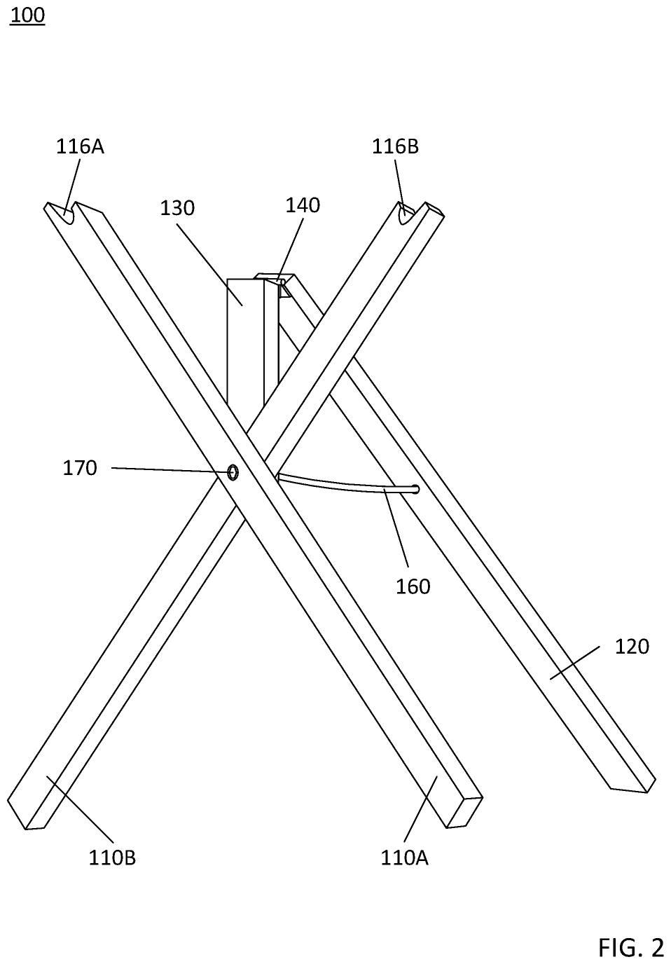

FIG. 2 illustrates a front perspective view of one embodiment of fishing rod stand 100 in an unfolded configuration. As illustrated in FIG. 2, when the fishing rod stand is in an unfolded configuration, back support 120 is an extended position with respect to swivel plate 130, and first front support 110A and second front support 110B are in a rotated position with respect to swivel plate 130. In some embodiments, front support 110A and/or front support 110B may be secured to swivel plate 130 by fastener 170. In some embodiments, fastener 170 may be a bolt. In some embodiments, the bolt may be secured to the swivel plate 130 by a threaded nut or insert (not pictured). Fastener 170 may be an adjustable fastener (e.g., a bolt connected to a lock nut), thus enabling increased rotational resistance between front supports 110A and 110B and swivel plate 130. Rotational resistance causes front support 110A and 110B to retain their rotated positions with respect to each other and to swivel plate 130. In some embodiments, fastener 170 is adjustable, and can be tightened to increase rotational resistance or loosened to reduce rotational resistance according to the preferences of the manufacturer or user. In some embodiments, fastener 170 is secured in a fixed fashion to swivel plate 130 such that fastener 170 cannot rotate with respect to the swivel plate 130, or cannot rotate past a maximum point (with respect to the swivel plate 130), such as, for example by incorporating a threaded t-nut insert into the hole in swivel plate 130 for fastener 170 (not pictured).

In some embodiments, back support 120 and swivel plate 130 are coupled using hinge 140, and are additionally attached with connector 160. Connector 160 prevents back support 120 from sliding too far from front supports 110A and 110B and swivel plate 130, to prevent collapse of fishing rod stand 100. In some embodiments, connector 160 is adjustable, and controls the maximum angle and/or distance between back support 120 and swivel plate 130. In some embodiments, connector 160 may allow back support 120 to open to a about a 60 to about a 70 degree angle with respect to swivel plate 130. In some embodiments, the maximum angle between swivel plate 130 and back support 120 may be selected by the manufacturer or user.

In some embodiments, connector 160 is secured to both back support 120 and swivel plate 130, and as further described with respect to FIGS. 6-8. When unfolding fishing rod stand 100, back support 120 is extended as far as permitted by connector 160. In some embodiments, connector 160 is a section of nylon rope, and is knotted on either side of back support 120 and swivel plate 130, such that when back support 120 is extended away from swivel plate 130, the nylon rope connector 160 pulls tight against the knots. In some embodiments, connector 160 adjustable. In some embodiments, a nylon rope connector 160 may be adjusted by retying a knot in a different place along the length of the nylon rope connector 160. The nylon rope may be cut manually or with an electric rope cutting gun.

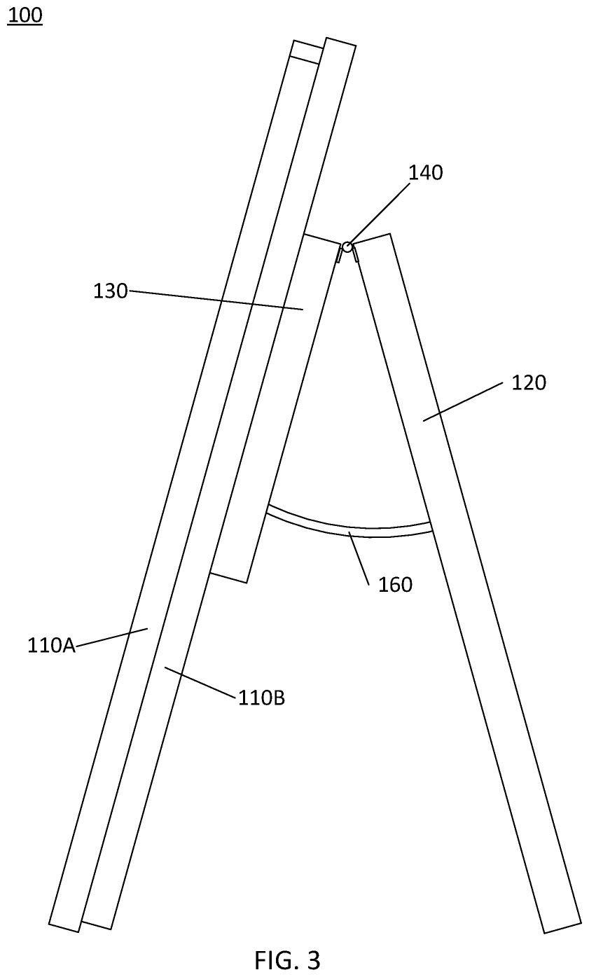

FIG. 3 illustrates a side view of one embodiment of fishing rod stand 100 in an unfolded configuration. Front supports 110A and 110B are in their rotated positions, and back support 120 is extended away from swivel plate 130. Swivel plate 130 is attached to back support 120 by hinge 140. In some embodiments, a fastener (not pictured) secures front supports 110A and 110B to swivel plate 130. Connector 160 prevents back support from extending too far from swivel plate 130 and fronts supports 110A and 110B.

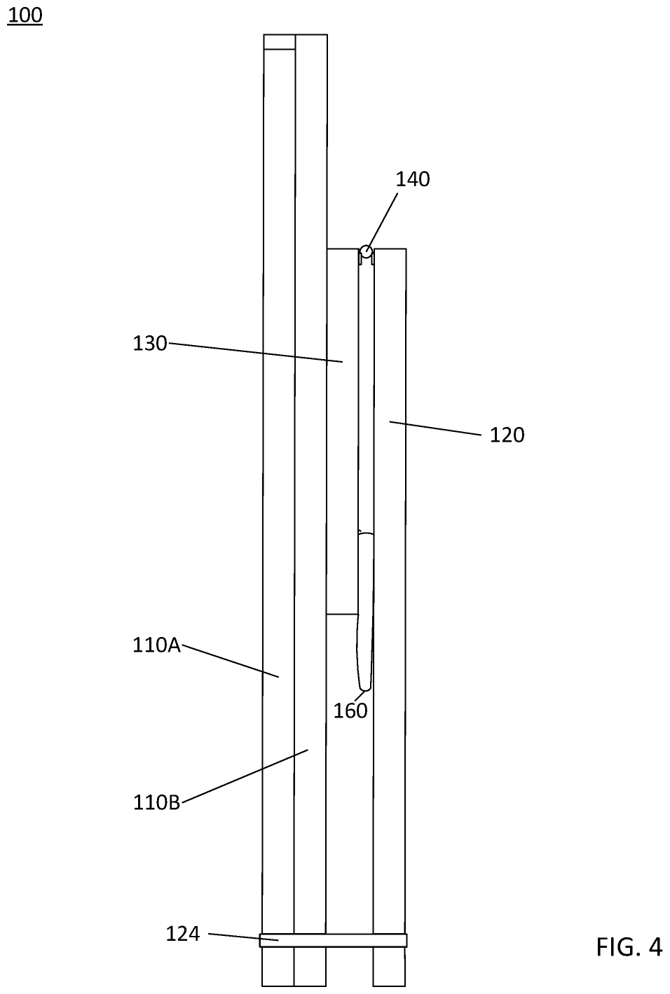

FIG. 4 illustrates a side view of one embodiment of fishing rod stand 100 in a folded configuration. Front supports 110A and 110B are in their un-rotated (i.e., aligned) positions, and back support 120 is proximate (e.g., retracted against) swivel plate 130. As illustrated in FIG. 4, back support 120 is in a retracted position with respect to swivel plate 130, and first front support 110A and second front support 110B are in an aligned position with respect to swivel plate 130. Swivel plate 130 is attached to back support 120 by hinge 140. In some embodiments, fastener (not pictured) secures front supports 110A and 110B to swivel plate 130. In some embodiments, connector 160 remains attached but is not extended (e.g., not engaged). In some embodiments, fishing rod stand 100 includes a carrying handle (not pictured) to facilitate the transportation of fishing rod stand 100 in folded configuration.

In some embodiments, a security strap 124 is wrapped around front supports 110A and 110B and back support 120. Security strap 124 is further described along with back support 120 with respect to FIG. 6.

FIG. 5 illustrates a standalone view of one embodiment of front support 110. Front support 110 can be the same as one or both front supports 110A, 110B of FIGS. 1-4. In some embodiments, front support 110A and front support 110B of FIGS. 1-4 are mirror images of each other. Referring to FIG. 5, front support 110 includes a beam 112 with a cradle 116 (e.g., forming a recess, cut-out, slot, etc.) at one end. In some embodiments, beam 112 measures between about twelve and about thirty-six inches in length, a width of about one to about four inches, and a thickness of about one-quarter inch to about two inches.

In some embodiments, cradle 116 has a high side 117 and a low side 115. In some embodiments (not pictured), cradle 116 forms a slot and each side of the slot is of equivalent height. In some embodiments, the area between high side 117 and low side 115 resembles a “J”-shape (one side is higher than the other) as shown in FIG. 5. In some embodiments, the area between the sides of cradle 116 resembles a “U”-shape (both sides are substantially the same height, not pictured). In some embodiments, the area between the sides of cradle 116 resembles a “V”-shape (not pictured). The design of cradle 116 is unique in that high side 117 holds the fishing rod firmly in place while low side 115 allows for a quick pick up when a fish strikes or bites the bait. In this way, low side 115 provides easy access to the fishing rod while also preventing the fishing rod from sliding down front support 110. In some embodiments, cradle 116 may not be part of beam 112 (e.g., is not formed by cutting or machining beam 112), but rather may be attached to beam 112 using a fastener (not pictured). In some embodiments, the beam 112 may be made of a solid piece of wood, for example, marine plywood, or another rigid water resistant material such as fiberglass, plastic, and/or aluminum.

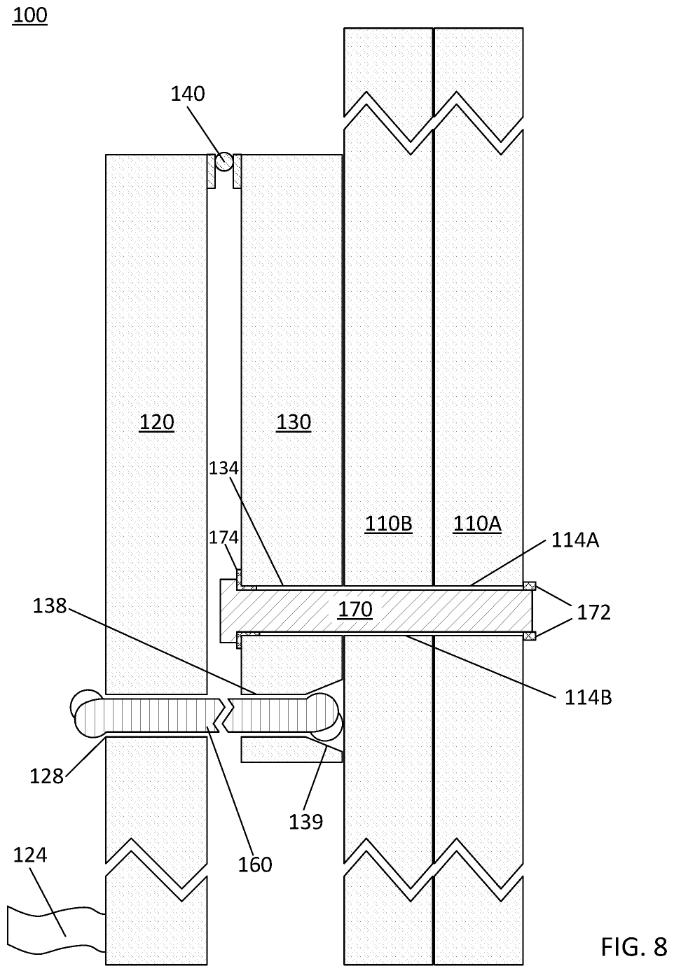

In some embodiments, rotation stop 118 is attached to beam 112 with a fastener such as a bolt or with an adhesive such as wood glue, and rotation stop 118 restricts the rotation of front support 110 with respect to swivel plate (e.g., swivel plate 130 of FIGS. 1-4). In some embodiments, rotational movement of front support 110 may also be restricted with respect to another front support, (e.g., 110B of FIGS. 1-4). In some embodiments, the rotation stop 118 enables front support 110A and/or front support 110B to rotate in one direction with respect to swivel plate 130, and restricts (or stops) front support 110A and/or front support 110B from rotating in the opposite direction with respect to swivel plate 130. For example, to properly extend the fishing rod stand, front support 110A can rotate clockwise and front support 110B can rotate counterclockwise. In this example, the rotation stop 118 can stop front support 110A from rotating counterclockwise, and similarly the rotation stop 118 can stop front support 110B from rotating clockwise. The restriction of the rotational movements of the front supports is further described with respect to FIG. 8. In some embodiments, rotation stop 118 resembles a flat washer. In some embodiments, rotation stop is made of zinc-plated metal, stainless steel, aluminum, other corrosion resistant metals, rigid plastic or nylon, fiberglass, and/or treated (such as marine plywood) or untreated wood. In some embodiments, rotation stop 118 is about one half inch to about one-and-a-half inches in diameter. In some embodiments, rotation stop 118 is a three-quarters inch zinc-plated flat washer. In some embodiments, a fastener hole 114 may be drilled in front support 110 to attach front support 110 to a swivel plate (e.g., swivel plate 130 of FIGS. 1-4) with a fastener (e.g., fastener 170 of FIG. 2). In some embodiments, rotation stop 118 is installed above fastener hole 114 on front support 110, for example between about one and about six inches above the fastener hole 114. In some embodiments, a second rotation stop (not pictured) may be installed below fastener hole 114 on front support 110, for example between one-half and two inches below fastener hole 114 to restrict rotation of two front supports (e.g., 110A and 110B with respect to FIGS. 1-4) from rotating open past a set point.

In one embodiment, one or more notches 119 may be cut into front support 110 to accommodate additional objects (such as elongated objects 150A and 150B with respect to FIG. 1). In one embodiment, notches 119 cut into front support 110 accommodate more objects (such as elongated objects 150A and 150B with respect to FIG. 1) when in certain positions, such as, for example, when front supports (such as front supports 110A and 110B with respect to FIGS. 1-4) are more aligned with the horizontal plane and or resembles a squashed “X” shape (e.g., front supports 110A-B are rotated so that tops of front supports 110A-B are separated from each other and bottoms of front supports 110A-B are separated from each other to be in an unfolded state).

FIG. 6 illustrates a standalone view of one embodiment of back support 120. Back support 120 comprises a beam 122 with a hinge mount 126 at one end. In some embodiments, back support 120 measures between about ten and about twenty-six inches, with a width of about one to about three inches, and a thickness of about one-quarter inch to about one-and-a-half inches. Back support 120 may be made of a solid piece of wood, for example marine plywood, or of another rigid waterproof material such as fiberglass, plastic, and/or aluminum. In some embodiments, back support 120 attaches to a swivel plate (e.g., swivel plate 130 of FIGS. 1-4) via a hinge (e.g., hinge 140 of FIGS. 1-4) secured at hinge mount 126, and may extend away from the swivel plate. In some embodiments, hinge mount 126 is recessed into beam 122. In some embodiments, the recess is cut manually and/or mechanically with a saw, router, or other cutting tool. In some embodiments, hinge mount includes mounting holes for a hinge (e.g., hinge 140 of FIGS. 1-4). In some embodiments, connector hole 128 is drilled in back support 120 to facilitate attachment of a connector (e.g., connector 160 of FIGS. 2-4). In some embodiments, connector hole 128 allows a nylon rope connector (e.g., connector 160 of FIGS. 2-4) to pass through back support 120. The nylon rope connector is then knotted on the other side of back support 120 such that the rope cannot pass back through connector hole 128. In some embodiments, back support 120 includes a support notch (not pictured) similar to a cradle (e.g., cradle 116 of FIGS. 1-5) and is further described with respect to FIG. 9.

In some embodiments, back support 120 includes security strap 124. Security strap 124 may be used to secure fishing rod stand 100 when folded for travel, convenience, storage, or any other reason. In some embodiments, security strap 124 is a flexible material with a coarse texture similar to the hook in a hook and loop fastener, such as Velcro®. In some embodiments, a portion of hook and loop fastener may be attached to front support 110A such that security strap 124 attaches to the portion of hook and loop fastener when used to secure fishing rod stand 100. In some embodiments, security strap 124 is a flexible material with a hook or buckle on one end and a loop or receiving buckle on the other. In some embodiments, security strap 124 is an elastic material which may be stretched to encompass the fishing rod stand 100 in a folded configuration. In some embodiments, security strap 124 can measure about six to eighteen inches in length. In some embodiments, security strap 124 can be stapled to back support 120 near the bottom, for example between about half inch and about two inches from the first distal end of back support 120 on the opposite end from hinge mount 126 (e.g., hinge mount 126 is at the second distal end of back support 120). In some embodiments, security strap can be attached manually or with an electric staple gun. In some embodiments, security strap 124 can be cut to size manually or with an electric cutting gun.

FIG. 7 illustrates a standalone view of one embodiment of swivel plate 130. Swivel plate 130 comprises a beam 132 with a hinge mount 136 at one end, a fastener port 134, and a connector port 138. In some embodiments, swivel plate 130 has a length of about four to about ten inches, a width of about one to about three inches, and a thickness of about one-quarter inch to about one-and-a-half inches. In some embodiments, back support 120 attaches to a swivel plate (e.g., swivel plate 130 of FIGS. 1-4) via a hinge (e.g., hinge 140 of FIGS. 1-4) secured at hinge mount 126, and may extend away from the swivel plate. In some embodiments, hinge mount 126 is recessed into beam 122. In some embodiments, the recess is cut manually and/or mechanically with a saw, router, or other cutting tool. In some embodiments, hinge mount includes mounting holes for a hinge (e.g., hinge 140 of FIGS. 1-4). In some embodiments, fastener port 134 may be used to fasten the front supports to the swivel plate (e.g., front supports 110 and swivel plate 130 of FIGS. 1-4). In some embodiments, a fastener (e.g., fastener 170 of FIGS. 1-4) secures to an insert (e.g., a t-nut, not pictured) in fastener port 134. In some embodiments, (not pictured) a fastener (e.g., fastener 170 of FIGS. 1-4) extends through swivel plate 130 and back support 120 can have a cut-out to accommodate the extended length when fishing rod stand 100 is folded. In some embodiments, connector port 138 (e.g., hole, channel) is cone-shaped with the cone base on the opposite side of, and facing away from, a back support (e.g., back support 120 of FIGS. 1-4). In some embodiments, the cone-shape of connector port 138 is to allow the knot tied in connector 160 to recess out of the way to allow the swivel plate 130 to be proximate to front support 110B. In some embodiments, the cone-shape of connector port 138 is made with a drill bit, a router, a lathe, or other similar tool. The swivel plate 130 may be made of a solid piece of wood, for example, marine plywood, or of another rigid water-resistant material such as fiberglass, plastic, and/or aluminum.

FIG. 8 illustrates a close-up side cross-sectional view of one embodiment of fishing rod stand 100, including back support 120, swivel plate 130, and two front supports 110A and 110B. In some embodiments, swivel plate 130 and each front support 110A and 110B are coupled with fastener 170. In some embodiments, fastener 170 may be a bolt of about one-quarter inch diameter, and about one to about three inches in length. In some embodiments, the bolt is secured to a threaded nut or threaded insert. For example, fastener 170 (e.g., bolt) can be secured with a t-nut 174 (e.g., a one-quarter inch t-nut), and t-nut 174 can be attached to swivel plate 130. Fastener 170 can further be secured with a lock nut 172 (e.g., a one-quarter inch lock nut). In some embodiments, fastener port 134 does not extend all the way through swivel plate 130, and fastener 170 secures to an insert (not pictured) in fastener port 134. In some embodiments, (not pictured) fastener 170 extends through swivel plate 130 and back support 120 can have a cut-out to accommodate the extended length when fishing rod stand 100 is folded. In some embodiments, one or more washers (not pictured) may be placed on fastener 170 between swivel plate 130 and front support 110B, between front support 110B and front support 110A, and/or between front support 110A and lock nut 172. The one or more washers may be made of plastic, steel, or nylon, for example.

In addition to securing front supports 110A and 110B to swivel plate 130, fastener 170 also increases rotational resistance between front supports 110A and 110B and swivel plate 130. Rotational resistance prevents free rotation of front supports 110A and 110B. Fastener 170 and lock nut 172 can be adjusted (e.g., tightened) to prevent front supports 110A and 110B from rotating freely, thus allowing front supports 110A and 110B to retain their rotated positions with respect to swivel plate 130 when the fishing rod stand is unfolded. In some embodiments, fastener 170 is adjustable and can be tightened to increase rotational resistance or loosened to reduce rotational resistance according to the preferences of the manufacturer or user.

In some embodiments, front supports 110A and/or 110B may have rotation stop (illustrated as rotation stop 118 in FIG. 5). Rotation stop 118 can prevent improper rotation of front supports 110A and 110B. For example, improper rotation can result when the cradle (e.g., cradle 116A of FIG. 2) is facing the wrong way. That is, in order to prevent the fishing rod from sliding down the front support, the high side of the fishing rod cradle faces the outside of the fishing rod stand when it is unfolded, while the low side of the fishing rod cradle faces toward the inside of the fishing rod stand (as illustrated in FIG. 1). The rotation stop 118 can prevent the front supports 110A, 110B from rotating in the opposite direction, thus avoiding having the high side of the cradle facing toward the inside of the fishing rod stand.

In some embodiments, back support 120 may have security strap 124. Security strap 124 can be wrapped around fishing rod stand 100 in its folded configuration to prevent unwanted movement. For example, the security strap 124 can wrap around the bottom of the back support 120 and both front supports 110A, 110B. In some embodiments, security strap 124 may be attached to front supports 110A and/or 110B.

Fishing rod stand 100 can be easily set up by un-securing security strap 124, grasping the bottom of the two front supports 110A, 110B, and rotating each until the front supports form a shape resembling an “X.” In some embodiments, the resulting side angle between each front support 110 is about 70 to about 100 degrees. The swivel plate 130 and back support 120 can be rotated and centered in the “X” created by the two front supports 110A, 110B. Back support 120 is then extended as far from swivel plate 130 as connector 160 allows, for example to an angle of about 40 to about 70 degrees. In some embodiments, connector 160 is a nylon rope which is threaded through connector port 138 through connector hole 128 in back support 120 and connector hole 139 in swivel plate 130. Connector 160 can be knotted on both ends. The connector port 138 can have a cone-shape on one or both ends to conceal the knot tied in the connector 160. FIG. 8 illustrates the connector hole 139 as having a cone-shape, which can allow swivel plate 130 to be proximate to front support 110B when the fishing rod stand is in a folded configuration.

FIG. 9 illustrates a front perspective view of one embodiment of fishing rod stand 100 in an unfolded configuration. In some embodiments, front support 110A and/or front support 110B may be secured to swivel plate 130 by fastener 170. In some embodiments, front supports 110A and 110B do not extend past fastener 170 by more than about one half inch to about three inches. In some embodiments, back support 120 has a notched cradle 127 to support a single fishing rod. In some embodiments, the support notch is about one-half inch to one-and-a-half inches in diameter. In some embodiments the support notch may be machined with a drill or router. In some embodiments, front supports 110A and 110B and back support 120 are about six to about sixteen inches in length, and swivel plate 130 is about two inches to about eight inches in length. In some embodiments front supports 110A and 110B do not have a cradle, (e.g., fishing rod cradle 116A or 116B with respect to FIGS. 1-2, and FIG. 5). In some embodiments, the fishing rod stand 100 of FIG. 9 is configured to support a fishing rod for ice fishing.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of words “example” or “exemplary” is intended to present concepts in a concrete fashion. As used in this application, the term “or” is intended to mean an inclusive “or” rather than an exclusive “or.” In addition, articles “a” and “an” as used in this application and the appended claims should generally be construed to mean “one or more” unless specified otherwise or clear from context to be directed to a singular form.

Reference throughout this specification to “some embodiments” means that a particular feature, structure, or characteristic described is included in at least one embodiment. Thus, appearances of the phrase “in some embodiments” in various places throughout this specification are not necessarily all referring to the same embodiment.

As used herein, the terms “substantially,” “about,” and/or the like, in some embodiments refer to a range of 2% greater and 2% less, in some embodiments refer to a range of 5% greater and 5% less, in some embodiments refer to a range of 10% greater and 10% less, in some embodiments refer to a range of 15% greater and 15% less, and in some embodiments refer to a range of 20% greater and 20% less.

The terms “over,” “under,” “between,” “disposed on,” and “on” as used herein refer to a relative position of one material layer or component with respect to other layers or components. For example, one component disposed on, over, or under another component may be directly in contact with the other component or may have one or more intervening components. Moreover, one component disposed between two components may be directly in contact with the two components or may have one or more intervening components. Similarly, unless explicitly stated otherwise, one feature disposed between two features may be in direct contact with the adjacent features or may have one or more intervening features.

The above description is intended to be illustrative and not restrictive. For example, above-described examples (or one or more aspects thereof) may be used in combination with each other. Other implementations can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description, with each claim standing on its own as a separate implementation, and it is contemplated that such implementations can be combined with each other in various combinations or permutations. The scope of implementations of the disclosure should be determined with reference to the appended claims, along with the full scope of equivalents to which such claims are entitled.

In the drawings, which are not necessarily drawn to scale, like numerals may describe similar components in different views. Like numerals having different letter suffixes may represent different instances of similar components. The drawings illustrate generally, by way of example, but not by way of limitation, various implementations discussed in the present document.

What is claimed is:

1. A fishing rod stand comprising:
a swivel plate;
a first front support connected to a first distal end of the swivel plate, wherein the first front support forms a first cradle configured to support a fishing rod;
a second front support connected to the first distal end of the swivel plate; and
a back support connected to a second distal end of the swivel plate.

2. The fishing rod stand of claim 1, wherein the back support is connected to the swivel plate via a hinge.

3. The fishing rod stand of claim 1, wherein the fishing rod stand is configured to be folded from an unfolded configuration into a folded configuration, and wherein the fishing rod stand is configured to be unfolded from the folded configuration into the unfolded configuration.

4. The fishing rod stand of claim 3, wherein responsive to the fishing rod stand being in the folded configuration:
the back support is in a retracted position with respect to the swivel plate; and
the first front support and the second front support are in an aligned position with respect to the swivel plate.

5. The fishing rod stand of claim 3, further comprising:
a security strap attached to the back support, wherein the security strap is configured to wrap around the first front support and the second front support responsive to the fishing rod stand being in the folded configuration.

6. The fishing rod stand of claim 4, wherein the fishing rod stand is configured to unfold from the folded configuration by extending the back support from the retracted position with respect to the swivel plate and rotating the first front support and the second front support from the aligned position with respect to the swivel plate.

7. The fishing rod stand of claim 3, wherein responsive to the fishing rod stand being in the unfolded configuration:
the back support is in an extended position with respect to the swivel plate; and
the first front support and the second front support are in a rotated position with respect to the swivel plate.

8. The fishing rod stand of claim 7, wherein the fishing rod stand is configured to fold up from the unfolded configuration by retracting the back support from the extended position with respect to the swivel plate and rotating the first front support and the second front support from the rotated position with respect to the swivel plate.

9. The fishing rod stand of claim 1, further comprising:
a connector, wherein a first end of the connector is attached to the back support and a second end of the connector is attached to the swivel plate, and wherein a maximum angle between the back support and the swivel plate is based on length of the connector.

10. The fishing rod stand of claim 9, wherein the maximum angle between the back support and the swivel plate is adjustable.

11. The fishing rod stand of claim 1, further comprising a rotation stop attached to the first front support, wherein the first front support is configured to rotate one direction with respect to the swivel plate.

12. The fishing rod stand of claim 1, wherein the back support, the swivel plate, and the first cradle are made of a rigid waterproof material.

13. The fishing rod stand of claim 12, wherein the rigid waterproof material is one of marine plywood, plastic, fiberglass, or aluminum.

14. The fishing rod stand of claim 1, wherein the swivel plate is connected to the first cradle via an adjustable fastener, wherein the adjustable fastener is configured to prevent free rotation of the first front support and the second front support relative to the swivel plate, and wherein adjustments to the adjustable fastener adjust resistance to rotation of the first front support and the second front support.

15. An elongated object stand comprising:
a swivel plate;
a first front support connected to a first distal end of the swivel plate, wherein a first distal end of the first front support is configured to support a first elongated object;
a second front support connected to the first distal end of the swivel plate; and
a first distal end of a back support rotatably connected to a second distal end of the swivel plate, and wherein a second distal end of a back support is configured to contact an external surface.

16. The elongated object stand of claim 15, wherein a second distal end of the first front support is configured to contact the external surface.

17. The elongated object stand of claim 15, wherein a first distal end of the second front support is configured to support a second elongated object, and wherein a second distal end of the second front support is configured to contact the external surface.

18. The elongated object stand of claim 15, wherein the elongated object comprises a handle.

19. The elongated object stand of claim 15, wherein the elongated object is one of a hot dog roasting stick, a marshmallow roasting stick, or a cooking spit.

20. The elongated object stand of claim 15, further comprising:
a folded configuration, wherein the elongated object stand is configured to be folded from an unfolded configuration into the folded configuration; and
the unfolded configuration, wherein the elongated object stand is configured to be unfolded from the folded configuration into the unfolded configuration.
